(19) United States
(12) Patent Application Publication
(10) Pub. No.: US 2007/0142150 A1
(43) Pub. Date: Jun. 21, 2007

(54) Link plate for a plate-link chain

(75) Inventor: Aurel Vietoris, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/588,101

(22) Filed: Oct. 26, 2006

Related U.S. Application Data
(60) Provisional application No. 60/730,270, filed on Oct. 26, 2005.

(51) Int. Cl. F16G 13/04

(52) U.S. Cl. 474/212; 474/213

(57) ABSTRACT

A link plate and a plate-link chain for a motor vehicle drive system. A large number of link plates are articulatingly connected with each other by rocker members that extend transversely to the longitudinal direction of the plate-link chain. The link plates include teeth that are separated by a recess that allows the teeth to be elastically deflectable relative to each other. At least one tooth of a link plate includes an elongated region a recess positioned between the inner side and the outer side of the tooth so that the amplitude and duration of impact impulses generated when sides of the link plate teeth contact a toothed wheel are changed to improve the chain acoustics during operation of the drive system.

### BACKGROUND OF THE INVENTION

1. FIELD OF THE INVENTION

The present invention relates to a link plate for a plate-link chain for use in a drive system. The invention also relates to a plate-link chain that is made using link plates according to the invention, as well as to a chain drive that incorporates such a plate-link chain and a vehicle that includes such a chain drive.

2. DESCRIPTION OF THE RELATED ART

Both link plates and plate-link chains of the type referred to above are known in many forms from the known state of the art, as is explained hereinafter. When using a plate-link chain as a toothed chain, which runs at a fixed transmission ratio between two toothed wheels, the impulses of the impacts of the link plates on the tooth faces of the toothed wheels causes a structure-borne noise to be introduced into the system the acoustic manifestation of which is negative. The “tooth meshing frequencies” that arise due to the impact impulse are present at all rotational speeds. The rotational speed of the system merely determines the frequency, which becomes higher the faster the chain or chain drive rotates.

It is known to optimize the acoustic properties of a toothed chain by randomizing the lengths of the plates, for example. In addition, there is a possibility of optimizing the acoustics by using two toothed chains that are positioned parallel and that run at an offset of half a plate length from each other.

An object of the present invention is to reduce the impact impulses of the plates on the tooth faces, and thus to optimize the intensity of the entry impulses and the times over which they act on the toothed wheel.

### SUMMARY OF THE INVENTION

In accordance with the present invention, that object is achieved by a link plate for a toothed chain, the plate having an outer side and an inner side with two teeth, each of which is formed by an inner side and an outer side. Two openings are provided in the link plate that each receive at least one joinder element. The peripheral contour of the link plate and the spacing between the openings are elastically changeable.

By introducing elastically changeable or springing components in the form of the link plate or spring plate in accordance with the invention into the entry process of the plate onto the tooth face, it is possible to reduce the strength of that impulse, which results in a clear improvement of the acoustics. During the entry process the link plate or spring plate in accordance with the invention first comes into contact with the tooth face of the toothed wheel. After that first contact, the geometry of the link plate in the form of the spring plate changes as a result of link plate deflection. The link plate or spring plate in accordance with the invention then stops deflecting, and its outside contour then corresponds exactly with the outside contour of a normal plate that is used in that toothed chain. That mechanism changes the entry impulse in terms of both time and amplitude, and in favor of better acoustics.

To that end, the link plate in accordance with the invention is made thicker at the location where it first touches the toothed wheel, so that it has an extension compared with the equivalent peripheral contour of a normal plate. The contact causes the plate first to deflect and then to stop deflecting, so that it then has the original outer geometry of a normal plate.

An advantageous embodiment of a link plate in accordance with the invention is distinguished by the fact that a recess is provided between the inner side and the outer side of at least one tooth.

The possibility thereby exists to use the geometric design of the recess or slot in terms of length, width, positioning, and shape to adjust or optimize the resulting spring characteristics of the link plate. That optimizing and design possibility permits matching the spring characteristics to the critical operating points in the particular case, in order to achieve the best acoustic effect by changing the entry impulse, as described above.

If appropriate, several recesses or slits can be made on the link plate, including on the opposite tooth of the link plate.

The result of such an arrangement is that with the spring-like link plate the spacing between the openings for the joinder elements remains constant, which ensures that the chain length does not change as the result of the springiness.

With a link plate in accordance with the invention it can be advantageous if the recess tapers down starting from the peripheral contour.

It can be advantageous for reasons of strength, for example, if the recess ends at an enlargement.

With a link plate in accordance with the invention, it can be advantageous if the recess limits the elastic variability of the tooth deflection.

In order to be able to bring additional damping into the system, for example, it can be advantageous if the plate, which has a front side and a back side, has increased roughness on at least one of those sides, so that when the teeth of the link plates are deflected the rough plate sides can rub against each other.

To that end the roughness can be increased by processing the plate material or by means of a coating.

In addition, the invention relates to a plate-link chain, made up at least of a plurality of plates and joinder elements that articulatingly connect them, wherein at least individual ones of the plates are shaped in accordance with the invention.

With a plate link chain in accordance with the invention, it can be advantageous if a pin-shaped part or pairs of rocker elements are provided as each joinder element.

In addition, the invention relates to a chain drive that is constructed using a plate-link chain in accordance with the invention, as well as to a vehicle having such a chain in a drive system.

Further, it is known that such link plates, as well as the plate-link chains assembled from them, are limited in their ability to transmit power, and that the possibility thus exists, for example, that a link plate will be damaged by power or load peaks and will fail. That failure can be manifested in breaking of the link plate, where starting from that link plate a failure or breaking of the entire plate-link chain can follow, since all the additional link plates that are positioned between the same joinder pieces must share in taking over the power or load transmission of the broken link plate, and hence are more highly loaded. That higher loading results in the individual link plates coming closer to the limit of their power transmitting capability, or even exceeding it.

Another advantageous embodiment of the invention shows possibilities for providing a link plate and a plate-link chain that utilizes it, which has higher strength. In addition, wear can be reduced and the elastic elongation of the link plate or the chain can be smaller. Not least, the embodiment is intended to result in needing to assemble fewer parts to produce a plate-link chain. That is achieved by designing the plate thickness of at least individual link plates to be greater, so that therefore the plate-link chain in accordance with the invention is thicker.

The result is larger contact surfaces between a link plate and an articulation member in the form of a rocker member that extends into an opening in the chain link, and to a large proportion of clean cuts with a smooth stamped surface. Furthermore, that results in very good perpendicularity between rocker member and link plate. A clean contact surface of that sort can reduce or even completely avoid shearing of the chain strand. The reduced pressure also enables reduction, and in the best case avoidance, of edge flow.

In consideration of the stamping quality and the flexural load on the rocker member, the plate thickness cannot be increased arbitrarily. It must also be taken into consideration that the tool and die costs increase disproportionately, depending upon the stamping thickness.

With a such a design of a link plate and its use in a toothed chain, the additional advantage arises that the tilting effect when the chain enters the toothed wheel, caused by a moment between tooth and plate, is favorably influenced, since good perpendicularity of plate to tooth is ensured. That results in better guidance, and reduction or avoidance of shear loading in the teeth. Furthermore, lower pressure occurs as a result, so that edge flow can be reduced or avoided.

Some dimensional relationships that are tangible in numerical terms have proven to be especially favorable. It is especially advantageous, for example, if the ratio of pitch I to plate thickness d is in the range of 3.7 to 5.5. It is also advantageous if the ratio of the height of the rocker members h to the plate thickness d is between 1.3 and 1.9. A ratio of the rocker member width w to the plate thickness d in the range between 0.8 and 1.2 is also especially advantageous. Furthermore, it is especially advantageous if the ratio of plate land width s to plate thickness d is in the range between 0.8 and 1.2.

As mentioned earlier, the present invention also relates in a particular arrangement to a plate-link chain, in particular for a vehicle transmission, a vehicle power train, or a vehicle engine auxiliary drive, having a large number of link plates articulatingly connected with each other by rocker members. The rocker members extend transversely to the longitudinal direction of the plate-link chain, and curved contact surfaces are formed on the rocker members and the link plates, along which contact surfaces the rocker members and link plates are in contact with each other to transmit force. The respective contact surface has a width that extends transversely to the longitudinal direction of the plate-link chain, and when regarded in a sectional view running transversely to the width, in the longitudinal direction of the plate-link chain, an arc length.

There are various configurations for plate-link chains of the type described herein, depending upon their use in the vehicle drive system. When used in a stepless, conical-disk chain-driven variable speed drive (CVT) as part of the vehicle transmission, the rocker members have specially shaped end faces by which the tractive force between the conical disks and the chain is transmitted as frictional force. In most other applications in the vehicle drive system the plate-link chain is a toothed chain, i.e., on at least one side the link plates have teeth by which the tractive force is transmitted between toothed wheels and the chain. Toothed chains of that sort have become known in the state of the art, for example through U.S. Pat. No. 4,906,224. Such toothed chains are employed at a plurality of locations in the vehicle drive system, for example in all-wheel transfer cases, in front-mounted transverse transmissions for bridging the center-to-center distance from the differential, as drive chains of a hydraulic auxiliary unit within the transmission, as the valve gear timing chain of an internal combustion engine, or also as drive chains of other auxiliary equipment of the vehicle (coolant pump, lubricant pump, air conditioning compressor, generator, starter motor, hybrid auxiliary motor, brake booster, and the like).

A plate-link chain of the type described herein is made up of a multitude of link plates, which are articulatingly connected with each other by rocker members.

The transmission of force between the rocker members and the link plates takes place at contact surfaces which are formed on both the rocker members and the link plates, and along which the rocker members and the link plates are in contact with each other. The rocker members are also referred to as pins, which are placed in pairs as rocker joints in two openings in the plate, which have often grown together into one large opening in the case of chains for belt-driven conical-pulley transmissions.

Various functional surfaces are formed on the rocker members. The pair of rocker members positioned opposite each other in an opening of the plate-link chain are in contact with each other at the rolling region or roller surfaces. When the chain bends, a relative rolling motion by the angle of bend dictated by the geometry of the rocker members occurs at that location.

The contact surfaces of the rocker members are in contact with contact surfaces of the link plate, so that surface pressures occur between the contact surfaces of the link plates and the contact surfaces of the rocker members. Those contact surfaces must fulfill multiple requirements. First, the surface pressures that occur should not become too great because of the shape of the contact surfaces, and second, the contact surfaces should also function as anti-turning protection, so that the rocker members do not turn in the openings of the link plates.

For that purpose, plate-link chains that have segmented contact surfaces with two significantly different radii per segment have already become known. For example, U.S. Pat. No. 6,277,046 shows a plate-link chain having two contact surfaces on the rocker member with two different radii. Through those different radii an anti-turning protection is achieved, so that the rocker members do not turn in the opening of the link plates. Another known plate-link chain is described in U.S. Pat. No. 5,236,399, which implements anti-turning protection through the fact that, again, two different radii are provided on the contact surfaces, or the centers of the radii are offset.

In addition to that anti-turning protection, the contact surfaces must also fulfill the requirement of a break-proof and fatigue-resistant plate-link chain. For that purpose, the surface pressures in the contact zone between the rocker members and the link plates must not exceed prescribed values. According to previous understanding, contact surfaces with little curvature and hence a large radius of curvature was necessary. According to the plate-link chains described above, an increase of the radius of curvature is therefore necessary in order to achieve a reduction of the contact pressure at the contact surfaces.

Surprisingly, it has now become evident that the responsibility for the occurrence of compressive stress spikes in the contact region of the contact surfaces of the rocker members and the plate-link chain does not rest with the existence of a small radius of curvature (and hence a large curvature), but rather local stress spikes occur more frequently in the transition region between different radii of curvature. That leads to the recognition that in the known plate-link chains significant stress spikes are present in the transition region from one radius of curvature to another radius of curvature, even when that transition runs tangentially, i.e., without a sharp bend.

A corresponding illustration is shown in FIG. 1 of the drawing. It shows that a compressive stress spike occurs in the transition region between the small radius of curvature designated by K and the large radius of curvature designated by G, but that the compressive stresses are not significantly greater in the region of the small radius of curvature than in the region of the large radius. The insight is thus that the small radius of curvature is not responsible for the occurrence of locally elevated compressive stress spikes, but that the region of transition from one radius of curvature to another radius of curvature represents a problem point.

That is evident from the fact that although the roller surfaces on the rocker members are intended for turning when the plate-link chain bends, turning of the rocker members occurs at the contact surfaces, so that even in the case of plate-link chains with anti-turning protection, relative rotation occurs in the contact surface region of the link plates of the plate-link chain and of the rocker members, i.e., a shearing motion occurs between the rocker member and the link plate at the contact surfaces, which results in a mismatch of the contact surface at the transitions from one radius of curvature to a different radius of curvature. Therefore, the curvature of the link plate no longer matches the curvature of the rocker member.

The shearing motion results in a transition from region support in the contact zone between the rocker member and the link plate to a linear support, viewed over the width of the rocker member, and hence to elevated contact pressure in that contact zone, so that the result is the pressure maximum shown in FIG. 1 of the drawing. That circumstance has not been taken fully into account previously, since according to conventional understanding attention has been directed only to a greatest possible radius of curvature to reduce the loads in the contact surface region between the rocker members and the link plates.

Hence there is a conflict of goals, to the effect that in the contact surface region attention must be paid to the requirements of permissible surface pressures, on the one hand, and on the other hand measures must also be taken to counteract turning of the rocker members relative to the link plates.

It is possible to design a plate-link chain for a vehicle drive, the chain having a large number of link plates articulatingly connected with each other by rocker members. The rocker members run transversely to the longitudinal direction of the plate-link chain and there are curved contact surfaces formed on the rocker members and on the link plates, along which surfaces the rocker members and link plates are in contact with each other to transmit force. The respective contact surface if the link plate has a width that extends transversely to the longitudinal direction of the plate-link chain, and when regarded in a sectional view running transversely to the width in the longitudinal direction of the plate-link chain, an arc length, and the contact surface has at least three regions with different curvatures along the arc length.

In other words, the result is a plate-link chain that has contact surfaces along its curved length which, regarded in a sectional view along the longitudinal direction of the plate-link chain, have at least three regions with different curvature, so that large jumps in the curvature are prevented but nevertheless regions with small and large radii of curvature are provided, in order to counter turning of the rocker members relative to the link plates.

That utilizes the insight that in contrast to the known insights it is not important to provide the smallest possible curvatures with large radii of curvature in the contact surface region, but that there should be a sufficient number of different curvatures of the contact surface of the rocker members and the contact surface of the link plates, but that jumps in curvature that result in high stress spikes should be avoided.

According to an advantageous improvement, provision is made so that the ratio of the greatest curvature to the smallest curvature is a factor of at least two. That design achieves the result that there is sufficient anti-turning protection of the rocker members relative to the link plates, and together with the feature that the contact surface is provided with at least three different curvatures along its arc length or curve length, that there are also sufficiently small jumps in curvature present so that unacceptably high compressive stresses do not occur at the contact surfaces in the region of the jumps in curvature.

There is also provision that the curvatures in the at least three regions can remain constant within the individual regions along the arc length, i.e., so that the curve length or arc length can be composed of at least three circular-arc segments, regarded in a sectional view along the axial longitudinal direction of the plate-link chain. As a result, the jumps between the different curvatures of the arc segments are small, and regarded in terms of radius of curvature, for rocker members of a plate-link chain for a vehicle drive system, jumps of the individual radii of curvature can occur, for example, from 1 mm to 3 mm and then to 5 mm, compared to a too large jump in radius from 1 mm to 5 mm.

It is also provided that the curvatures in the at least three regions change within the individual regions along the arc length. In other words, that means that constant curvatures are not provided in the three different regions, but that the curvatures can, for example, change continuously within the individual regions. That makes contact surfaces possible which, regarded in an axial longitudinal section view of the plate-link chain, are made up of spiral segments whose curvature—and hence also their radius of curvature—changes continuously along the arc length. In addition to those spiral segments, contact surface forms are also possible which, regarded in the axial longitudinal sectional view, are made up of elliptic segments, whose curvature varies continuously between a minimum value and a maximum value. Also possible as segments of the curve length, in addition to those shapes, are sections of hyperbolas or parabolas, or, quite generally, contact surfaces that have curved segments along the arc length whose second derivative is constant.

According to an improvement, provision is also made so that the contact surface has curve segments along the arc length whose smallest radius of curvature along the arc length is located substantially in the middle of the arc length.

By having the smallest radius of curvature located substantially in the middle of the arc length, the greatest curvature falls outside of the respective end region of the contact surfaces. That results in the rocker members becoming stiffer than in an arrangement where the smallest radius of curvature is in the region of the respective ends of the contact surfaces, and hence they deflect less. With the rocker members deflecting less, the tractive force is distributed more evenly over all of the adjacent link plates and the link plates achieve a greater fatigue strength, and the plate-link chain as a whole is able to transmit a greater tractive force.

With a plate-link chain of that type, a result is that pronounced jumps in contact stress no longer occur in the transition region between different radii of curvature of the contact surfaces. The anti-turning protection of the rocker members in the openings of the link plates is also increased, in comparison with known plate-link chains.

### BRIEF DESCRIPTION OF THE DRAWINGS

The structure, operation, and advantages of the present invention will become further apparent upon consideration of the following description, taken in conjunction with the accompanying drawings in which:

FIG. 1 is an enlarged, fragmentary side view showing the pattern of the surface pressure at the surface contact region of the contact surfaces of a rocker member and a link plate in a known configuration having two significantly different radii of curvature;

FIG. 2 is a side view of a known plate-link chain for use in a CVT transmission, wherein A designates the region shown in FIG. 1 in enlarged form;

FIG. 3 is an enlarged side view of a first embodiment of a link plate and rocker member in accordance with the present invention;

FIG. 4 is an enlarged end view of a second embodiment of a rocker member in accordance with the present invention;

FIG. 5 is an enlarged end view of a third embodiment of a rocker member in accordance with the present invention;

FIG. 6 is an enlarged end view of the rocker member of FIG. 5 for further explaining individual features;

FIG. 7 is an enlarged, fragmentary side view similar to FIG. 1 showing the surface pressure pattern in the contact surface region between a rocker member and a link plate of a plate-link chain in accordance with the present invention;

FIG. 8 is a perspective view of a link plate and a rocker member in accordance with the present invention wherein the link plate includes teeth for use of the plate in a toothed chain;

FIG. 9 shows an embodiment of a link plate link in accordance with the invention; and

FIG. 10 is a graph to illustrate entry impulses.

### DESCRIPTION OF THE PREFERRED EMBODIMENTS

As explained earlier, FIG. 1 shows the pattern of the surface pressure in the contact pressure region between a rocker member and a link plate of a known plate-link chain. In the transition region between the small radius of curvature designated with K and the large radius of curvature designated with G, a pronounced maximum of the contact pressure between the rocker member and the link plate occurs, the cause of which is the jump in radius of curvature between the small radius of curvature K and the large radius of curvature G.

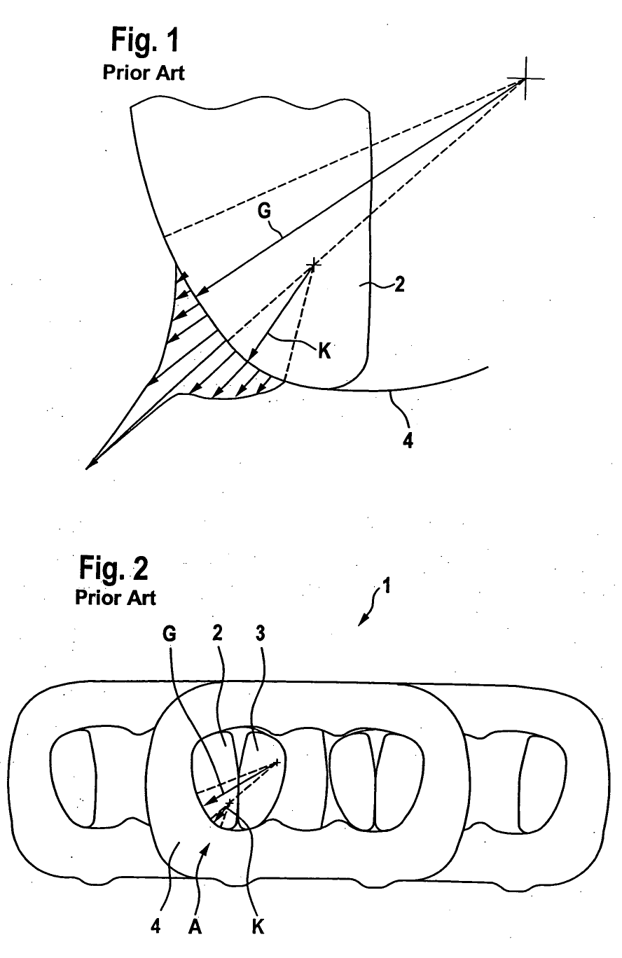

FIG. 2 of the drawings shows a detail of a known CVT plate-link chain 1 that is made up of a large number of rocker members 2, 3 and link plates 4. The region designated as A in FIG. 2 is shown in enlarged form in FIG. 1 of the drawing, so that FIG. 1 shows contact surfaces of rocker member 2 and link plate 4.

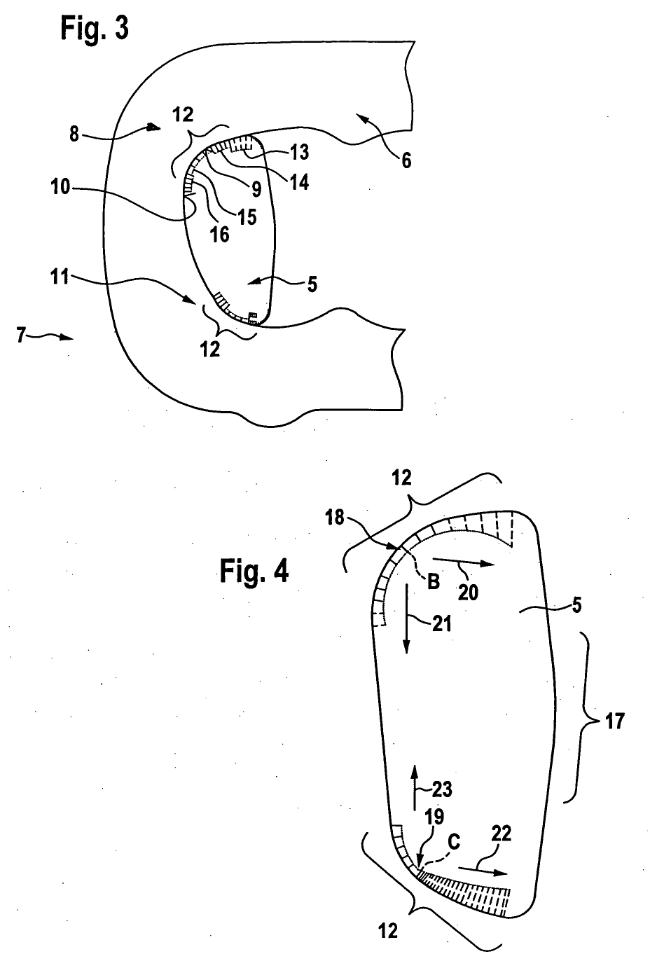

FIG. 3 of the drawings shows an enlarged representation of a rocker member 5 and a link plate 6 of a plate-link chain 7 according to a first embodiment of the present invention.

As can be seen in FIG. 3, there are two contact surface regions 8 and 11 between rocker member 5 and link plate 6, contact surface region 8 being formed by a contact surface 9 on rocker member 5 and a contact surface 10 on the link plate 6. In a similar manner, contact surface region 11 is composed of a contact surface on rocker member 5 and a complementarily formed contact surface on link plate 6.

Rocker member 5 and link plate 6 are in contact with each other at contact surface 9 and contact surface 10 to transmit force. Since link plate 6 has a certain thickness in the direction transverse to the drawing plane of FIG. 3, and a plurality of those link plates lying side by side are in contact with the same rocker member 5, the tractive force transmitted by plate-link chain 7 is distributed over the individual contact surface regions between the rocker members and the link plates. In an axial longitudinal section running transversely to the width of plate-link chain 7, each contact surface 9, 10 has an arc length or curve length that is represented in the drawing by a bracket 12.

FIG. 3 of the drawings shows a first embodiment of a plate-link chain according to the present invention, in which contact surface 9 on rocker member 5, and complementary to it, contact surface 10 on link plate 6, have been formed with regions having different curvatures. In order to be able to show those curvatures graphically, in FIG. 3 of the drawing the regions with different curvatures are shown with dashed lines with correspondingly differing radii of curvature 13, 14, 15, 16, the respective radius of curvature 13, 14, 15, 16 being drawn perpendicularly at the regions with different curvatures, in order to be able to graphically show the different curvatures at the contact surfaces 9, 10, which are difficult for the human eye to perceive visually.

FIG. 3 of the drawings makes it clear that the curvature in the region of radius of curvature 13 is smaller than in the region of radius of curvature 14, so that the radius of curvature of region 13 is greater than that of region 14. In the same way, the radius of curvature of region 15 is even smaller than of region 14, and accordingly the curvature of region 15 is greater than of region 14. Thus, contact surface 9 of rocker member 5, and complementary thereto contact surface 10 of link plate 6, already has three different curvatures in contact surface region 8 along the arc length or curve length of contact surfaces 9, 10. In addition, FIG. 3 also shows that yet another, fourth region, with a radius of curvature 16 that differs from radii of curvature regions 13, 14, 15, is formed at contact surfaces 9, 10 along the arc length 12. In the same way, contact surface region 11 also has regions with different curvatures, wherein only three regions having different surface curvatures are provided there.

FIG. 4 of the drawings shows a rocker member 5 of a plate-link chain according to a second embodiment of the present invention, wherein that rocker member is a rocker member of a plate-link chain for a belt-driven conical-pulley transmission.

On rocker member 5, reference numeral 17 designates the roller surface with which rocker member 5 rolls against the opposing rocker member (again, a pair of rocker members is involved), the basic configuration being visible on the basis of FIG. 2 of the drawing. Rocker member 5, in turn, has two contact surfaces 18, 19, which are positioned against complementarily formed contact surfaces of a link plate (not shown). The upper contact surface 18 has a point designated as B at which the maximum curvature is located, i.e., where the radius of curvature, which is again shown perpendicular to contact surface 18 by way of explanation, is at its minimum. Starting from point B the radius of curvature increases in both directions, so that the curvature becomes continuously smaller at the contact surface in both directions starting from point B. Starting from point B, the radius of curvature increases in the direction of arrow 20 corresponding to segments of ellipses, and increases in the direction of arrow 21 corresponding to segments of a spiral.

FIG. 4 shows a similar condition with the maximum curvature in the lower contact surface 19 starting from point C, where the radius of curvature increases in the direction of arrow 22 corresponding to a hyperbolic segment, and increases in the direction of arrow 23 corresponding to a segment of one arm of a parabola.

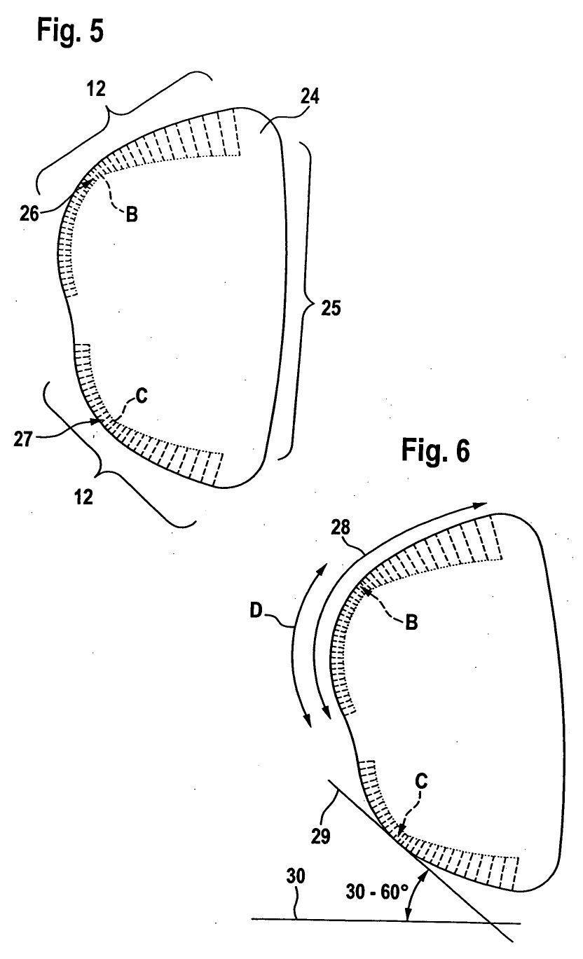

FIG. 5 of the drawings shows a representation similar to FIG. 4, where the rocker member 24 shown in FIG. 5 of the drawings is a rocker member of a toothed chain that can be employed, for example, as a toothed chain for a drive, or as a toothed chain for conveyors. Rocker member 24 also has a roller surface 25, on which it can roll against the associated rocker member of the pair of rocker members. Rocker member 24 also has an upper contact surface 26 and a lower contact surface 27. The configuration of upper contact surface 26 is chosen so that starting from point B the radius of curvature (the radius of curvature is again represented by dashed lines perpendicular to the contour of the contact surface) increases in both directions of contact surface 26 along the arc length, which is again indicated by bracket 12. In the same way, the radius of curvature at the lower contact surface 27 increases in both directions from the point designated as C with maximum curvature (corresponding to minimum radius of curvature).

As has been further recognized, a more compressionally rigid design of the rocker members is possible if the largest curvature, and hence the minimum radius of curvature of the contact surface, runs approximately in the middle of the contact surface, regarded over the arc length or curve length of the contact surface.

FIG. 6 of the drawings serves to explain that interrelationship. The letters B and C are used again to designate the points on the upper contact surface and the lower contact surface, respectively, that have the maximum curvature, and hence the minimum radius of curvature within the respective contact surface. As can be seen clearly on the basis of the drawing, points B and C are located approximately in the middle of respective arc lengths 28, beneath which the region with the dashed radii of curvature also runs. Although it was mentioned above that the point with the maximum curvature along the arc length is located approximately in the middle of the contact surface (measured over the arc length 28), it has turned out that similarly beneficial effects are achieved when point B or C is located in the range D of 40% to 60% of the arc length. That region matches an angular range of 30 to 60 degrees of the tangent to the lower contact surface of the rocker member, the angle of 30 to 60 degrees being measured between the tangent 29 and the direction 30 in which the chain runs. If the point of the particular contact surface with the maximum curvature is located within 40% to 60% of the total length of the arc length 28, or within 30 to 60 degrees of the tangent 29 to the running direction 30 of the chain, the result is stiff rocker members which are therefore less susceptible to deformation, which, in turn, results in an increase in the tractive force that can be transmitted by the plate-link chain or toothed chain.

FIG. 7 of the drawings shows another contact pressure pattern in the lower contact surface chosen in the representation, between rocker member 5 and link plate 6 of a plate-link chain (where the term plate-link chain also includes a toothed chain). A comparison between the contact pressure pattern of a known plate-link chain according to FIG. 1 of the drawing and the contact pressure pattern according to FIG. 7 of the plate-link chain, make it immediately clear that the pronounced contact pressure maximum shown in FIG. 1 has disappeared. To show the contact pressure pattern at the contact surface, in both drawings a representation standardized to each other was chosen, so that the lengths of the respective arrows also represent the magnitude of the contact pressure at the particular point on the contact surface being considered. That makes it clearly evident on the basis of a visual check that the pronounced contact pressure maximum according to FIG. 1 has disappeared.

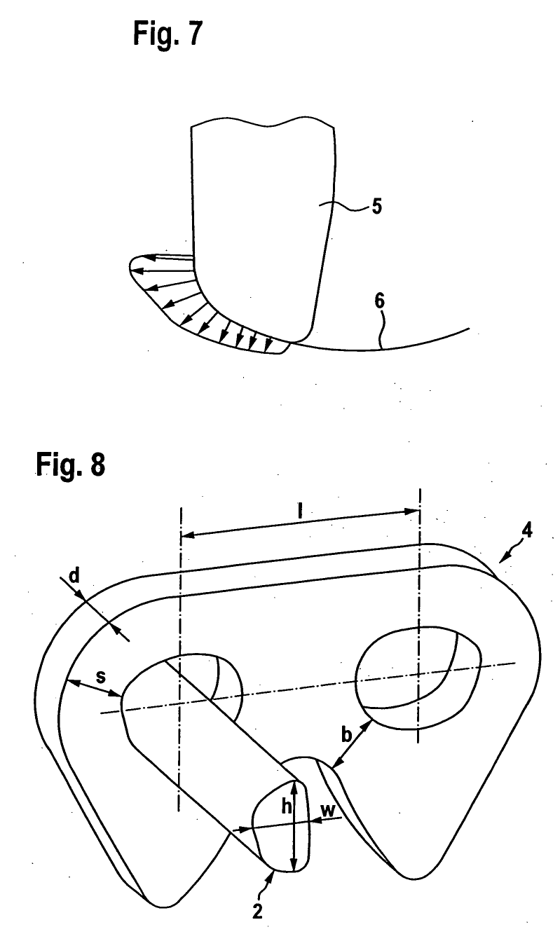

FIG. 8 shows a link plate 4 according to the invention, as well as a single rocker member 2 of a pair of rocker members. The designations used in FIG. 8 serve to clarify the previously mentioned dimensional ratios, and have the following meanings:

d: plate thickness

s: outer land width

l: pitch

h: rocker member height

w: rocker member width

b: inner land width

Accordingly, the dimensional ratios presented earlier, according to the invention, are as follows:

I/d=3.7 to 5.5, and/or

h/d=1.3 to 1.9, and/or

w/d=0.8 to 1.2, and/or

s/d=0.8 to 1.2.

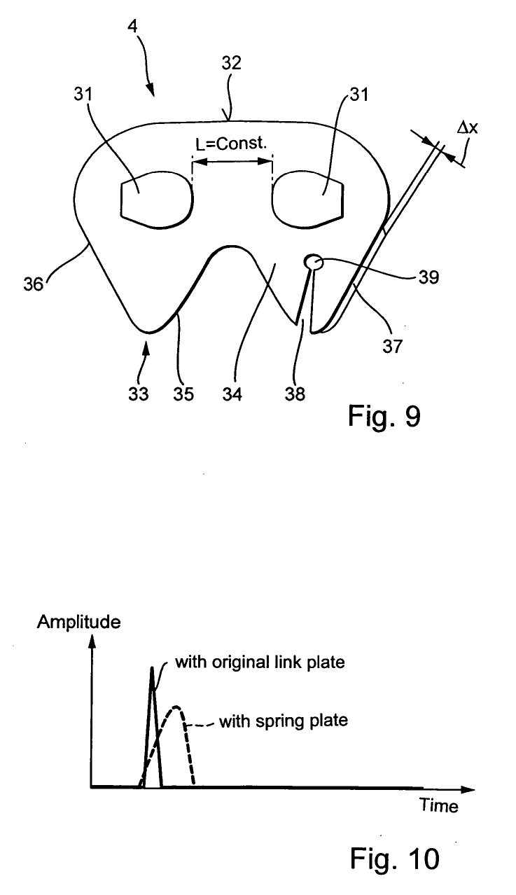

FIG. 9 shows a link plate 4 in accordance with the invention that has two openings 31 to receive joinder pieces or joinder elements (not shown). Link plate 4 has an outer side 32, and an inner side 33 that includes two teeth 34 that are each formed by an inner side 35 and an outer side 36. In addition, in the illustrated exemplary embodiment a tooth 34 has a thickened region 37 that extends by the distance Δx beyond the outer contour of a normal plate (not shown) which cooperates in the same plate-link chain together with the inventive link plate 4. In addition, it is shown in FIG. 9 that the spacing between the openings 31 for receiving joinder elements remains constant, as the result of the manner of functioning of the inventive link plate 4, as described below.

In the exemplary embodiment in accordance with FIG. 9, a tooth 34 has a recess 38, which begins in the region of the tooth between the inner side 35 and the outer side 35 and that is oriented in the direction toward the outer side 32 of the link plate. The recess, which is shown as tapered in that example, extends to an enlargement 39 that serves to relieve stress peaks and that prolongs the life of the inventive link plate 4.

In the interaction of a plate-link chain that is constructed using inventive link plates 4 with a toothed wheel (not shown), the thickened region 37 of the link plate 4 first strikes the tooth that is interacting with it. Other, normal link plates that do not have that thickened region 37 do not yet have any tooth contact at that time. The result is that the tooth 34 is elastically deformed by the amount Δx of the thickened region 37, until its outside contour corresponds to that of a normal link plate. That elastic deformation is made possible by the recess 38, which with appropriate design can also limit that elastic deformation in that its sides are touching each other, i.e., they coincide.

With that springy behavior the spacing between the openings 31 for receiving joinder elements remains constant, so that the chain length also remains constant and unchanged.

FIG. 10 shows a graph in which the amplitude of the entry impulse is shown as a function of time, comparing the original plate with the spring plate in accordance with the invention. It can be seen that with the original plate there is a relatively high entry impulse amplitude 40, which operates over a relatively short time interval. When spring plates are utilized the peak of that entry impulse amplitude 42 is significantly reduced and extends over a longer time interval, so that the occurrence of the entire entry process is softer. It can be seen that the entry impulse amplitude is significantly weakened by the spring effect, and that the impulse occurs more softly, because of the reduction of the amplitude of the entry impulse and the simultaneous lengthening of the impulse time.

The resulting advantages were described above.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A link plate for a toothed chain, said link plate comprising: an outer side and an inner side and having two teeth, each of which includes an inner side and an outer side, and two spaced openings for receiving at least one link plate joinder element, wherein the peripheral contour of the plate is elastically changeable without changing the spacing between the openings.

2. A link plate according to claim 1, including a recess positioned between the inner side and the outer side of at least one tooth.

3. A link plate according to claim 2, wherein the recess tapers inwardly from an outer periphery of the link plate.

4. A link plate according to claim 2, wherein the recess terminates inwardly at an enlargement.

5. A link plate according to claim 1, wherein the elastic changeability of the peripheral contour of the link plate is limited by the size of the recess.

6. A link plate according to claim 1, wherein the link plate has a front face and a back face, and wherein at least one face has an increase in surface roughness.

7. A link plate according to claim 6, wherein the surface roughness is achieved by physically roughening the surface.

8. A link plate according to claim 6, wherein the surface roughness is achieved by a surface coating.

9. A plate-link chain comprising: a plurality of interconnected link plates and joinder elements connecting the link plates in an articulating manner, wherein at least individual ones of the link plates include an outer side and an inner side and having two teeth, each of which includes an inner side and an outer side, and two spaced openings for receiving at least one link plate joinder element, wherein the peripheral contours of the at least individual ones of link plates are elastically changeable without changing the spacing between their openings.

10. A plate-link chain according to claim 9, wherein the joinder elements are pin-shaped components.

11. A plate-link chain according to claim 9, wherein the joinder elements are pairs of rocker members.

12. A chain drive including a plate-link chain comprising: a plurality of interconnected link plates and joinder elements connecting the link plates in an articulating manner, wherein at least individual ones of the link plates include an outer side and an inner side and having two teeth, each of which includes an inner side and an outer side, and two spaced openings for receiving at least one link plate joinder element, wherein the peripheral contours of the at least individual ones of link plates and the spacing between their openings are elastically changeable without changing the spacing between the openings.

13. A motor vehicle including a chain drive comprising: a plurality of interconnected link plates and joinder elements connecting the link plates in an articulating manner, wherein at least individual ones of the link plates include an outer side and an inner side and having two teeth, each of which includes an inner side and an outer side, and two spaced openings for receiving at least one link plate joinder element, wherein the peripheral contours of the at least individual ones of link plates are elastically changeable without changing the spacing between the openings.
